(19) United States
(12) Patent Application Publication
(10) Pub. No.: US 2009/0295584 A1
(43) Pub. Date: Dec. 3, 2009

(54) ELECTRONIC EAS TAG DETECTION AND METHOD

(75) Inventor: Steven V. LEONE, Lake Worth, FL (US)

Correspondence Address: Christopher & Weisberg, P.A., 200 East Las Olas Boulevard, Suite 2040, Fort Lauderdale, FL, 33301, US

(73) Assignee: Sensormatic Electronics Corporation, Boca Raton, FL (US)

(21) Appl. No.: 12/537,463

(22) Filed: Aug. 7, 2009

Related U.S. Application Data
(62) Division of application No. 11/755,127, filed on May 30, 2007.

(51) Int. Cl. G08B 13/14

(52) U.S. Cl. 340/572.3

(57) ABSTRACT

An apparatus and method for detecting and deactivating electronic article surveillance (“EAS”) tags in which a housing is affixable to at least one of a bar code scanner and a RFID scanner. An electronic circuit located is within the housing. At least one user observable indicator is controlled by the electronic circuit in which the at least one user observable indicator is affixed to the housing and provides a tag deactivation status.

### CROSS-REFERENCE TO RELATED APPLICATION

This application is a divisional of and claims priority to U.S. patent application Ser. No. 11/755,127, filed May 30,2007, entitled ELECTRONIC EAS TAG DETECTION AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to electronic article surveillance (“EAS”) systems, and more particularly to a tag deactivator for an EAS system.

### BACKGROUND OF THE INVENTION

EAS systems are designed to prevent unauthorized removal of an item from a controlled area. In a typical EAS system, tags designed to interact with an electromagnetic field located at the exits of the controlled area are attached to articles to be protected. If a tag is brought into the electromagnetic field or “interrogation zone”, the presence of the tag is detected and appropriate action is taken. For a controlled area such as retail store, the appropriate action taken for detection of an EAS tag may be the generation of an alarm. Some types of EAS tags remain attached to the articles to be protected, but are deactivated prior to authorized removal from the controlled area by a deactivation device that changes a characteristic of the tag so that the tag is no longer detectable in the interrogation zone.

The majority of EAS tag deactivation devices are fixed at a specific location, such as adjacent a point-of-sale (“POS”) station in a retail environment. If an article is purchased, and for whatever reason the attached EAS tag is not deactivated at the deactivator adjacent the POS station, the EAS tag will set off an alarm at the store exit. To then deactivate the EAS tag, the article must be brought back to the deactivator adjacent the POS station, which causes confusion and customer embarrassment. Handheld deactivators for EAS tags, sometimes known as “boot deactivators” that are part of a handheld bar-code scanner are known, but consist of only a passive demagnetizing magnet of alternating polarity. These devices provide no feedback to the user of the presence of an active tag or if the deactivation attempt was successful. Full function proximity handheld deactivators are superior in deactivation, but at the expense of added weight, manufacturing and purchase price and complexity.

Typical handheld bar-code scanners having boot deactivators are passive devices and must either touch or be in very close proximity to deactivate the EAS tags. As the use of source tagging, which is the application of EAS security tags at the source, e.g., the manufacturer of the article, grows, the EAS tags will be located somewhere on an item or in its packaging. Since the user cannot see the tag when the tag is hidden somewhere on an item or in its packaging, the user may be unable to determine if all EAS tags associated with the article have been deactivated. Thus, another limitation of current boot deactivators is that a user receives no feedback from the boot deactivator as to whether an EAS tag has been deactivated or if it remains active. Often times, the user will “rub” a product or its packaging multiple times with a handheld deactivator in hope of deactivating all associated EAS tags. At other times, the user will be forced to pick up a heavy or large-sized box and use a high-powered table top deactivator for deactivation. This takes time and extra effort at the point of sale. Consequently, there is a need for an improved EAS deactivating device, such as a boot deactivator with user observable feedback, to indicate when EAS tags are deactivated.

### SUMMARY OF THE INVENTION

The present invention advantageously provides a circuit, apparatus and method for electronic article surveillance (“EAS”) tag detection, deactivation and EAS tag activation status indication.

In accordance with one aspect, the present invention provides an apparatus for detecting and deactivating electronic article surveillance (“EAS”) tags. The apparatus includes a housing affixable to at least one of a bar code scanner and a radio frequency identification (“RFID”) scanner/reader. An electronic circuit is located within the housing. At least one user observable indicator is controlled by the electronic circuit. The user observable indicator is affixed to the housing and provides a tag deactivation status. Exemplary indicators can be visual, such as an LED, and/or audible, such as a piezo device or a speaker.

In accordance with another aspect, the present invention provides a method for generating deactivation status of electronic article surveillance (“EAS”) tags, in which a storage device of an electronic circuit is inductively charged. Communication is established with at least one EAS tag while operating the electronic circuit using the power stored in the storage device. The inductive charging of the storage device is disabled while communicating with the at least one EAS tag.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an EAS system for scanning a bar code of an item and deactivating an EAS tag constructed in accordance with the principles of the present invention;

FIG. 2 is a prospective view of a boot deactivator for use with the EAS system of FIG. 1 and constructed in accordance with the principles of the present invention;

FIG. 3 is a schematic diagram of an exemplary electronic circuit of the boot deactivator and constructed in accordance with the principles of the present invention;

FIG. 4 is a flowchart illustrating an exemplary logic process for the electronic circuit shown in FIG. 3 in accordance with the principles of the present invention; and

FIG. 5 is a flow chart of an exemplary tag detection and deactivation process in accordance with the principles of the present invention.

### DETAILED DESCRIPTION OF THE INVENTION

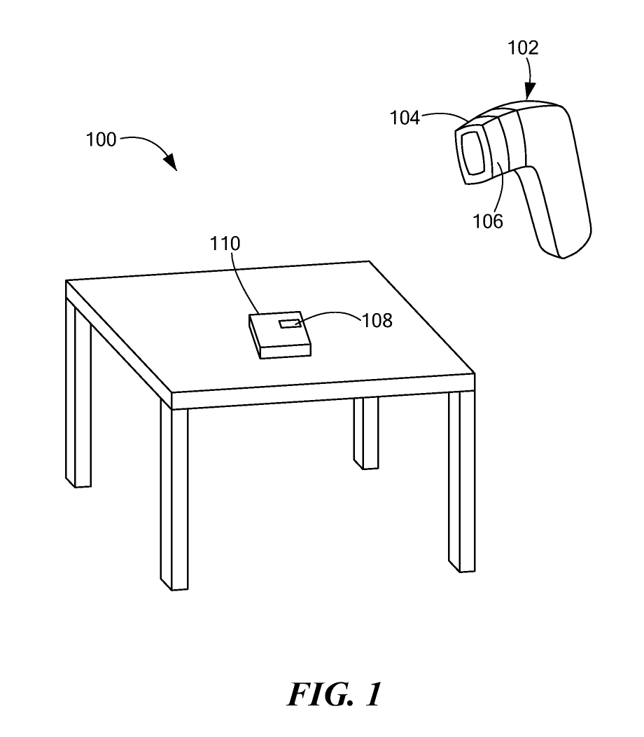

Referring now to the drawing figures in which like reference designators refer to like elements, there is shown in FIG. 1 a diagram of an exemplary system constructed in accordance with the principles of the present invention and designated generally as “100”. Electronic article surveillance (“EAS”) system 100 includes a monitoring system that creates a system detection zone also know as an “interrogation zone” at an access point for a controlled area (not shown). Upon entering the interrogation zone, an active EAS tag creates a disturbance in the zone, which is detected by the receiver of an EAS system 100. EAS systems, such as EAS system 100, range from very low magnetic frequencies through the radio frequency range. These different frequencies play a role in establishing the features that affect operation. The EAS system 100 includes a handheld barcode scanner 102 and a boot deactivator 104. In this embodiment, the boot deactivator 104 is attached near the tip portion 106 of barcode scanner 102, which is illustrated as a gun type scanner. Of course, placement of the boot deactivator 104 is not limited to the tip 106 of gun type barcode scanner 102, but can also be mounted at various locations, e.g., along the end of the handle portion of the gun type barcode scanner 102.

Moreover, the boot deactivator 104 is not limited to a gun type scanner but can be attached to other EAS handheld deactivators and devices such as tag detachers or RFID scanners (also known as RFID readers). The EAS system 100 further includes one or more security labels or EAS tags 108 located somewhere on an item 110 or in its packaging. EAS tag 108 can be a source tag which is not necessarily located on an outside surface of item 110. The EAS system 100 can further include a charging pad (not shown) for recharging a power source of the barcode scanner 102 and/or the boot deactivator 104. For example, the charging pad can be located with a table top price scanner at a POS checkout station.

In operation, the boot deactivator 104 can concurrently deactivate the EAS tag 108 when the scanner 102 scans item 110 for checkout. For example, the boot deactivator 104 can deactivate EAS tags 108 when the tip 106 of the scanner 102 is pressed against or in close proximity to the label 108. Since the boot deactivator 104 is attached to a portable handheld scanner 102, deactivation of labels or EAS tags on large, bulky or heavy merchandise is made easier. For example, in situations where merchandise such as a large wide-screen television set located within a large box and/or several boxes of drinking water located on a shopping cart are too heavy or too bulky for a clerk to place on a table deactivator. In this example, a handheld scanner 102 with a boot deactivator 104 provides the convenience of deactivating tags 108 located inside or on the surface of these boxes without requiring a clerk to lift the boxes and place them on a table top deactivator to deactivate the tags 108.

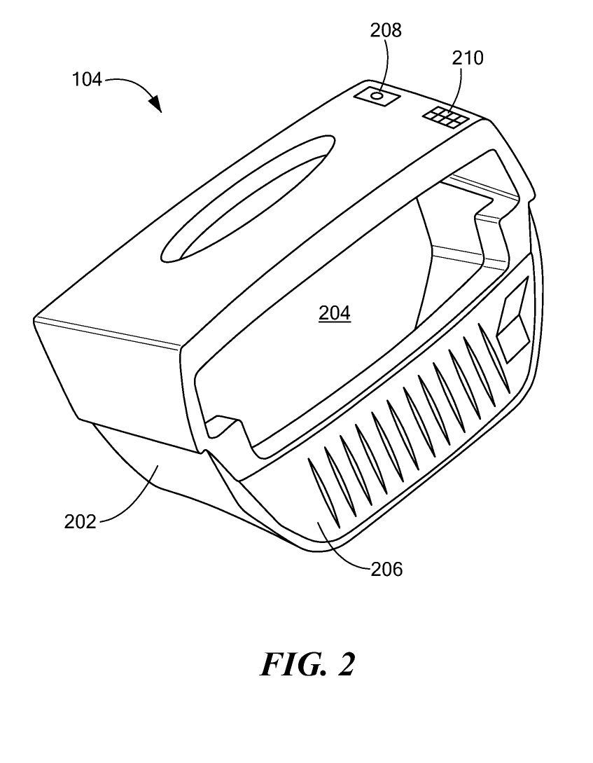

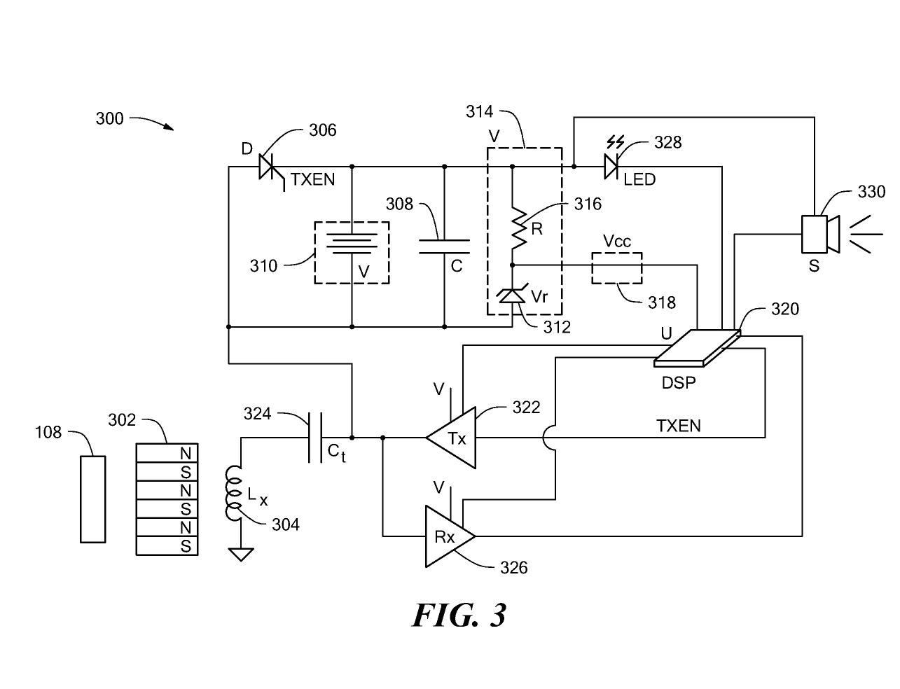

FIG. 2 illustrates in more detail the handheld boot deactivator 104 of FIG. 1. In this embodiment, the boot deactivator 104 includes an outer housing 202, which defines an aperture 204 and an electronic compartment 206. The outer housing 202 of boot deactivator 104 can be made of any suitable material including plastic or metal. The electronic compartment 206 of the housing 202 provides an area to locate an electronic circuit 300 (FIG. 3) for EAS tag detection, EAS tag deactivation and EAS tag deactivation status generation. The electronic compartment 206 can be an integrated part of the housing 202, a recessed area within the housing 202 or a separate protective structure arranged to mate with the housing 202. The electronic circuit 300 can be integrated into the electronic compartment 206 as shown in FIG. 2 or the electronic circuit 300 can be a standalone device and separate from the electronic compartment 206. The aperture 204 provides an unobstructed scan window for the scanner 102 (FIG. 1). Accordingly, when the scanner 102 generates a scanning beam, e.g., a laser beam, for scanning a barcode of an item 110, the beam is not blocked or obscured by the boot deactivator 104.

The boot deactivator 104 further includes one or more deactivation status indicators 208, 210. In this embodiment, indicator 208 is a visual indicator, such as a light emitting diode (“LED”) and/or indicator 210 is an audio indicator, such as a speaker that generates an acoustic signal, tone or audible sound. For example, a green LED 208 on the boot deactivator 104 alerts users when an active EAS tag 108 is detected, while a speaker 210 may generates a tone, e.g., a “beep” to indicate that deactivation of the tag 108 has been attempted. Silence and/or no LED illumination after such a tone implies that the EAS tag 108 was successfully deactivated. It is contemplated that the status indicators 208 and 210 can be any of type of indication method including a vibrator, a LED, a speaker, etc. The deactivation status indicators can be user observable indicators that can be integrated or fixed to the housing 202, in a recessed area within the housing 202 or in a separate protective structure arranged to mate with the housing 202.

Referring to FIG. 3 is a schematic diagram illustrating an exemplary electronic circuit 300 for an EAS system that can be used with the boot deactivator 104 (FIG. 2). Electronic circuit 300 can be located in electronic compartment 206 (FIG. 2) and integrated into the boot deactivator 104 to perform EAS tag deactivation and EAS tag deactivation status indication. Electronic circuit 300 and electronic compartment 206 are sufficiently small in size so that electronic circuit 300 is easily integrated into the boot deactivator 104.

The exemplary electronic circuit 300 includes a magnet 302 coupled to charging/transceiving coil 304. When magnet 302 and charging/transceiver coil 304 are placed in an electromagnetic field of a charging pad or table top deactivator, an alternating current (“AC”) is induced in the charging/transceiver coil 304. The induced AC current is rectified by a diode 306, such as a silicon controlled rectifier (“SCR”) diode that automatically commutates the AC current to produce a unidirectional current, i.e., direct current (“DC”), for charging a storage super-capacitor 308 and/or a small optional battery 310. In this embodiment, SCR diode 306 can be a 4-layer solid state device that is used to produce variable DC voltages from AC line voltage and is used for power switching, phase control, battery charging, and inverter circuits. In addition, the SCR diode 306 is used to maintain a constant output current or voltage for the electronic circuit 300. In this embodiment, a storage capacitor 308, such as a super-capacitor, and/or an optional battery 310 are connected in parallel to each other and either one can selectively serve as a power source for electronic circuit 300. As previously mentioned, battery 310 is optional since one embodiment of the electronic circuit 300 uses an inductive charging method to charge its power source.

Electronic circuit 300 uses the capacitor 308 and/or the battery 130 as a bus voltage source V, e.g., 5V, which is divided and regulated through a voltage divider 312. The voltage divider 312 includes a zener diode 314 connected in series with a resistor 316 and operates to provide the processor voltage, e.g., 3.3V across the zener diode 314. In general, the zener diode 314 permits current to flow not only in a forward direction, similar to conventional diodes, but also in a reverse direction when the voltage is larger than the rated breakdown voltage also known as “zener voltage.” The zener diode 314 has a greatly reduced breakdown voltage and regulates the voltage across the electronic circuit 300. An optional linear regulator 318 can be used regulate and/or to reduce or drop down the bus voltage across the zener diode supply voltage to a voltage range suitable for powering a digital signal processor (“DSP”) 320, e.g., 1.8 V to 3.3V.

DSP 320 provides for control and processing of signals to and from electronic circuit 300. In one embodiment, DSP 320 “wakes up” periodically from a low power mode and transmits a current through the charging/transceiver coil 304 via a transmitter driver 322 and a resonant capacitor 324 (the capacitor 324 and coil 304 form a resonant circuit) to generate a pulse interrogation signal for transmission to tag 108. In this embodiment, the transmitted pulse can be at an acousto-magnetic frequency of 58 kHz with less than 1.5 ms pulse width burst at a 36/30 Hz repetition rate (for 60/50 Hz local AC line frequency, respectively), so chosen to minimize interference with existing 60/50 Hz EAS systems. As briefly mentioned before, when acousto-magnetic systems transmit a magnetic frequency signal at 58 kHz in a pulsed pattern, the transmit signal energizes an acousto-magnetic tag in the detection zone. Upon completion of the transmit signal pulse, tag 108 responds by emitting a distinctive frequency signal. The tag signal can be at the same frequency e.g. 58 kHz, as the transmitted signal. During the period of time between pulses when the transmitter driver 322 is off, the receiver 326 can receive or detect the response signal transmitted by tag 108. The receiver 326 amplifies and filters the response signal of tag 108. The receiver 326 further passes the response signal of the tag 108 into an analog-to-digital (“A/D”) converter of the DSP 320.

The DSP 320 digitally filters the response signal received from the tag 108 and analyzes the spectrum of the response signal to obtain a profile of the tag 108. The DSP 320 also checks the response signal from the tag 108 to ensure it has the proper tag signature, e.g., the proper frequency with corresponding defined characteristics for synchronization to the transmitter, at the proper level of amplitude, and at the correct repetition rate. When these criteria are present for successive measurements, there is a strong probability that the tag 108 has been detected. This unique tag signature enables the acousto-magnetic technology driven electronic circuit 300 of the present invention to deliver wide surveillance coverage, a high tag detection rate, and relative immunity to false alarms. When the tag 108 is detected, the DSP 320 will trigger an indicator to alert a user by either lighting the LED 328 or sending a pulse to an acoustic transducer 330 such as a piezo-composite transducer or speaker. The LED 328 or the speaker 330 can be connected to the DSP 320 directly.

During the transmit mode, the SCR 306 prevents transmitted current from flowing into super-capacitor 308. During those periods when the electronic circuit 300 does not receive a response from a tag, the electronic circuit 300 is ready for charging its power supply. Because a charging/transceiver coil 304 and a tuning capacitor (or resonant circuit component) 324 are used for both electromagnetic signal transmission and inductive charging, the electronic circuit 300 can be charged by a table top deactivator operating at approximately 58 kHz, or by a charging pad operating at a frequency a few kHz above or below 58 kHz. In general, this frequency range does not interfere with the EAS system frequency, but is still suitable for charging the capacitor 308.

In operation, the electronic circuit 300 will activate temporarily, search for an EAS tag, and provide a status signal to a user. Using the energy produced from a standard acousto-magnetic table top deactivator and/or charging pad, the electronic circuit 300 can be self-powered and thus not require a battery or a battery replacement, which allows the electronic circuit 300 to be a completely environmentally sealed unit. Acousto-magnetic systems typically transmit magnetic frequency signals at 58 kHz in a pulsed pattern. The transmit signal energizes an acousto-magnetic EAS tag in the detection zone. When the transmit signal pulse ends, the EAS tag responds, emitting a single very distinctive frequency signal. The EAS tag signal is typically at the same frequency as the transmitter signal but may vary according to design requirements. Charging of the battery is performed with inductive coupling from the acousto-magnetic table top deactivator and/or a charging pad.

In operation, when the boot deactivator 104 receives a response from an EAS tag 108, the electronic circuit 300 located in the electronic compartment 206 detects whether the EAS tag 108 is deactivated and presents a deactivation status indicator for the EAS tag 108 using any type of indication method. For instance, the boot deactivator 104 can also include at least one indicator integrated into boot deactivator 104 for indicating a deactivation status of an EAS tag 108. Although FIG. 2 shows the electronic compartment 206 embedded in the bottom of the boot deactivator 104, this is for illustrational purpose as electronic compartment 206 can be integrated into the boot deactivator 104 in any configuration without departing from the scope and spirit of the invention.

The method of charging the electronic circuit 300 by use of a table top deactivator or a charging pad's field energy to inductively charge the super-capacitor 308 and/or to power the electronic circuit 300, can also be extended to other point of sale (“POS”) equipment such as a hard tag detacher, an EAS double checker, a barcode scanner, etc. An example of a known 58 kHz transmitting charger pad is a table top deactivator that continuously transmits a detection signal that can be used to charge the electronic circuit 300. In one embodiment, a small battery can be added to the boot deactivator 104 to increase detection range and improve device performance consistency. In another embodiment, the method of charging the electronic circuit 300 uses the relative motion of the magnet 302 of the boot deactivator 104 and the charging/transceiver coil 304 to generate the recharge. For example, the magnet 302 coupled to the boot deactivator 104 can be mounted so that it moves in a relatively small area with respect to the charging/transceiver coil 304 when a user shakes the boot deactivator 104. When this shaking occurs, a charge is generated by inductive coupling the charging/transceiver coil 304 and the acousto-magnetic magnet 302 thereby inductively charging the super-capacitor 308. Additionally, low power storage, i.e., low charge on the capacitor 308 or the optional battery 310 can be detected by the electronic circuit 300 to trigger a low battery status indicator such as a distinctive pattern LED flash or audible alarm that is different from the tag deactivation indicators.

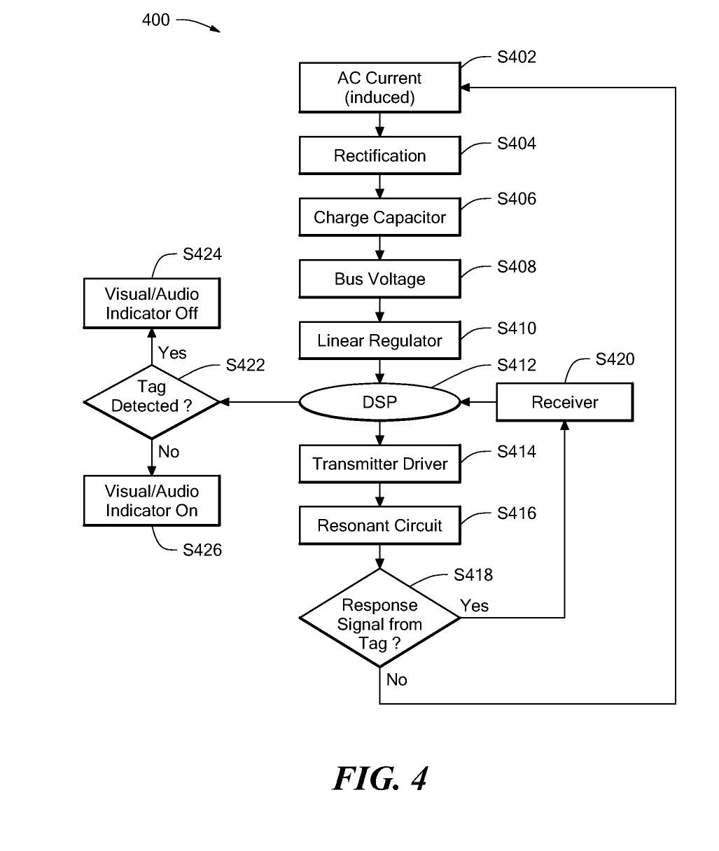

FIG. 4 is a flow chart illustrating an exemplary operation 400 of the electronic circuit 300 for detecting and deactivating an EAS tag and for generating tag deactivation status indicators. At step S402, an induced AC current is generated by inductive charging. At step S404, the induced AC current is rectified by the diode 306. Next at step S406, the rectified AC current can charge the storage super-capacitor 308. A bus voltage is developed at step S408. At step S410, linear regulator 312 supplies voltage to power the DSP 320. The optional linear regulator 312 drops the supply voltage as well as prevents the transmitted current from flowing back into the super-capacitor 308. At step S412, the DSP 320 “wakes up” periodically from a low power mode to process transmitted and received signals from/to EAS tags. At step S414, the DSP 320 sends a current through the transmit/receive coil via transmitter driver 322 (step S414) and resonant circuit including resonant capacitor 324 (step S416) to generate an interrogation signal for transmission to an EAS tag 108. At step S418, if the targeted tag 108 does not respond to the interrogation signal of electronic circuit 300 or if the electronic circuit is not detecting the EAS tag 108, the process can return to step S402. Otherwise, if there is a response from the EAS tag 108, a receiver circuit receives the response signal at step S420 and passes the response signal to the DSP 320 for processing of the response and any associated tag data contained in the response. Prior to passing the tag response signal to the DSP 320 for processing, a receiver circuit 328 amplifies and filters the tag response signal (step S420). Again, the DSP 320 processes the tag response signal to determine whether the tag response signal is valid and ready for deactivation, and if so transmits a deactivation signal to the tag 108 (step S422). When the tag response signal is valid, the circuit 300 generates the tag status indication using any indicator type, such as a visual indication, e.g., green LED, or an audible tone, such as a “beep” discussed above (step S424). The tag interrogation signal and the tag deactivation signal transmitted to the tag 108 via the coil 304 are referred to collectively herein as electromagnetic tag signals.

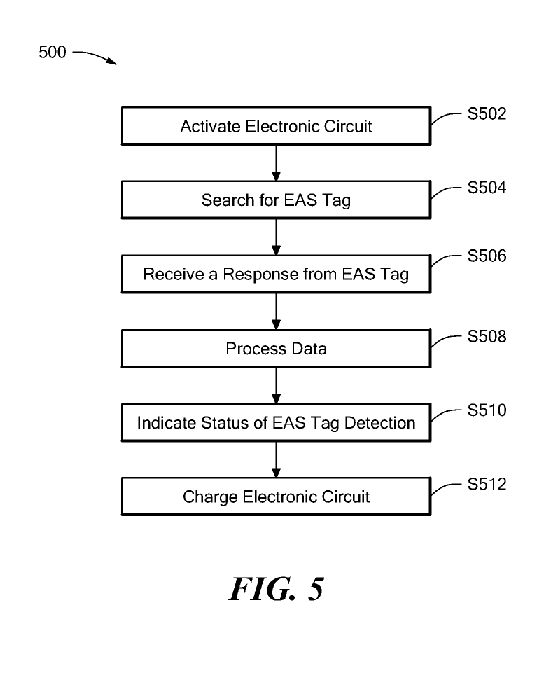

FIG. 5 is a flow chart 500 illustrating an exemplary method for deactivating the EAS tag 108. At step S502, an electronic circuit 300 for EAS tag deactivation and EAS tag detection status indication is activated upon an occurrence of a predetermined event. Once activation of the electronic circuit 300 is complete, the electronic circuit 300 searches for an EAS tag 108 by generating an interrogation signal (step S504). Upon receiving a correctly transmitted interrogation frequency, the tag 108 resonates and can be detected. A typical interrogation frequency for acousto-magnet tags is about 58 kHz, which will be used herein as an example. At step S506, the electronic circuit 300 receives the resonated response with associated tag data from the EAS tag 108. At step S508, the electronic circuit 300 processes the response signal with associated tag data to determine if the response signal is a valid EAS tag signal by examining the associated tag data for various attributes. For example, the response signal must have the proper spectral content and must be received in successive windows as expected. If the DSP 320 determines that the response signal is a valid EAS tag signal, then the DSP 320 may initiate deactivation, or indicate the detection of an EAS tag, depending on the particular mode of operation. At step S508, the when an EAS tag is detected, the electronic circuit 300 of boot deactivator 104 indicates the detected status of EAS tag 108 by activating the EAS tag status indicator, such as the illumination of LED 328 or the generation of an audio tone by speaker 330 (step S510). During the time periods when electronic circuit 300 does not transmit or receive signals to/from tag 108, electronic circuit 300 can be charged or recharged via the storage super-capacitor 308 or optional battery 310 (step S512). Of note, although charging/recharging is shown as step S512, it is understood that charging can occur at any idle point in the tag detection cycle.

The present invention advantageously provides and defines a portable circuit, apparatus and method for detecting tags attached to items in electronic article surveillance systems, deactivating the detected tags and generating a tag status indication.

The embodiments of the invention can take the form of an entirely hardware embodiment, an entirely software embodiment or an embodiment containing both hardware and software elements. It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An apparatus for detecting and deactivating electronic article surveillance (“EAS”) tags, the apparatus comprising:
a housing affixable to at least one of a bar code scanner and a RFID scanner;
an electronic circuit located within the housing; and
at least one user observable indicator controlled by the electronic circuit, the at least one user observable indicator being affixed to the housing and providing a tag deactivation status.

2. The apparatus of claim 1, wherein the electronic circuit includes:
a coil, the coil inducing a current when subject to an electromagnetic field and the coil also transmitting an electromagnetic tag signal;
a tuning capacitor in electrical communication with the coil, the tuning capacitor and the coil establishing a resonance for the transmission of the electromagnetic tag signal; and
a storage capacitor in electrical communication with the coil, the storage capacitor receiving the induced current from the coil.

3. The apparatus of claim 2, wherein the electronic circuit further includes a first diode in electrical communication with the coil and the storage capacitor, the first diode rectifying the induced current from the coil.

4. The apparatus of claim 3, wherein the electronic circuit further includes a voltage divider in electrical communication with the storage capacitor and the first diode, the voltage divider providing a processor voltage.

5. The apparatus of claim 5, wherein the electronic circuit further includes a linear voltage regulator in electrical communication with the voltage divider, the linear regulator regulating the processor voltage.

6. The apparatus of claim 1, wherein the electronic circuit includes a processor, the processor processing a response signal received from an EAS tag and controlling the at least one user observable indicator based on the response.

7. The apparatus of claim 6, wherein the processor determines an EAS tag deactivation status.

8. The apparatus of claim 1, wherein the at least one user observable indicator is a light emitting diode (LED) that provides a visual indication of a tag status.

9. A method for generating a tag detection status of electronic article surveillance (“EAS”) tags, the method comprising:
inductively charging a storage device of an electronic circuit;
communicating with at least one EAS tag while operating the electronic circuit using the power stored in the storage device; and
disabling the inductive charging of the storage device while communicating with the at least one EAS tag.

10. The method of claim 9, wherein the communicating with the at least one EAS tag includes transmitting a tag interrogation signal.

11. The method of claim 10, further comprising determining a tag status based on a response to the tag interrogation signal.

12. The method of claim 11, further comprising generating a user observable EAS tag detection indication based on the determined tag status.

13. The method of claim 9, wherein the disabling the inductive charging of the storage device includes disabling a rectifier diode.
